(19) United States
(12) Patent Application Publication
(10) Pub. No.: US 2021/0320548 A1
(43) Pub. Date: Oct. 14, 2021

(54) STATOR AND MOTOR

(71) Applicant: NIDEC CORPORATION, Kyoto (JP)

(72) Inventors: Shinji SHIMODAIRA, Kyoto (JP); Takayuki MIGITA, Kyoto (JP); Masato AONO, Kyoto (JP); Shota KAWASHIMA, Kyoto (JP)

(21) Appl. No.: 17/263,894

(22) PCT Filed: Jul. 8, 2019
(86) PCT No.: PCT/JP2019/026937

§ 371 Date: Jan. 28, 2021

(30) Foreign Application Priority Data
Aug. 3, 2018 (JP) 2018-146790

(51) Int. Cl. H02K 3/52

(52) U.S. Cl. CPC H02K 3/522; H02K 2203/09

(57) ABSTRACT

In a stator, a bus bar holder includes: a base; an annular inside wall protruding from a radially inner edge of the base; an annular outside wall protruding from a radially outer edge portion of the base; and a plurality of sidewalls connecting the inside wall and the outside wall. The base, the inside wall, the outside wall, and the sidewall constitute a plurality of recesses. The coil connection units of bus bars protrude from the base. Among the coil leaders, at least a part of the coil leaders is a first coil leader that is accommodated in the recess while the front end is bent onto the other side in the radial direction. The front end of at least one first coil leader is accommodated in each recess and connected to the coil connection unit in the recess.

### CROSS-REFERENCE TO RELATED APPLICATIONS

This is the U.S. national stage of application No. PCT/JP2019/026937, filed on Jul. 8, 2019, and priority under 35 U.S.C. § 119(a) and 35 U.S.C. § 365(b) is claimed from Japanese Patent Application No. 2018-146790, filed on Aug. 3, 2018.

### FIELD OF THE INVENTION

The present invention relates to a stator and a motor.

This application is based on Japanese Patent Application No. 2018-146790 filed on Aug. 3, 2018. This application claims priority benefit to Japanese Patent Application No. 2018-146790, the entire content of which is incorporated herein by reference.

### BACKGROUND

In a stator included in a motor, a crossover wire connecting two coils and a leader wire extending from the coil are arranged along a circumferential direction. In such a configuration, it is necessary to insulate the crossover wire and the leader wire in order to prevent a short circuit between the crossover wire and the leader wire and the coil. For example, there is a configuration in which the leader wire is coated with an insulating tube and insulated.

However, in the above configuration, it is necessary to cover the crossover wire and the leader wire with the insulating tube, which increases man-hours and time required for work of insulating the crossover wire and the leader wire. Additionally, work of arranging the crossover wire and the leader wire in the circumferential direction is difficult to automate, and is performed manually, for example. For this reason, the time required for the work of crawling the crossover wire and the leader wire in the circumferential direction also increases. As described above, in the above configuration, there is a problem in that the man-hours and time required for assembling the stator are increased to hardly improve productivity of the stator.

### SUMMARY

According to one aspect of the present invention, a stator of a motor including a shaft that rotates about a center axis, the stator includes: a stator core including a core back extending in a circumferential direction and a plurality of teeth extending in a radial direction from the core back; a plurality of coils that are constructed with a conductive member and mounted on the plurality of teeth; a bus bar holder that has an annular shape along the circumferential direction and is located on one side in an axial direction of the stator core; and a plurality of bus bars that are held by the bus bar holder and electrically connected to the coil. The bus bar holder includes: an annular base along the circumferential direction; an annular inside wall protruding from a radially inner edge of the base toward one side in the axial direction; an annular outside wall protruding from a radially outer edge portion of the base toward one side in the axial direction; and a plurality of sidewalls that protrude from the base toward one side in the axial direction and extend in the radial direction to connect the inside wall and the outside wall. The plurality of sidewalls are disposed apart from each other along the circumferential direction. The base, the inside wall, the outside wall, and the sidewall constitute a plurality of recesses, which are recessed on the other side in the axial direction, along the circumferential direction. The plurality of bus bars include a plurality of coil connection units connected to the coil. The plurality of coil connection units are disposed apart from each other along the circumferential direction, and located in the recess while protruding from the base toward one side in the axial direction. A pair of coil leaders, which are both ends of the conductive member, are led from each of the plurality of coils toward one side in the axial direction through one side in the radial direction of the bus bar holder. Among the coil leaders in the plurality of coils, at least a part of the coil leaders is a first coil leader that is accommodated in the recess while a front end is bent onto the other side in the radial direction. At least one of the coil connection units is located in each recess, and the front end of at least one of the coil leader is accommodated in each recess. The front end of the first coil leader is connected to the coil connection unit in the recess.

According to another aspect of the present invention, a motor includes the stator and a rotor radially opposed to the stator with a gap.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view schematically illustrating a motor according to an embodiment;

FIG. 2 is a perspective view illustrating a motor of the embodiment;

FIG. 3 is a sectional view illustrating the stator of the embodiment, and a sectional view taken along a line III-III in FIG. 2;

FIG. 4 is a perspective view illustrating a part of the stator of the embodiment;

FIG. 5 is a sectional view illustrating a part of the stator of the embodiment, and a sectional view taken along a line V-V in FIG. 2;

FIG. 6 is a perspective view illustrating a part of the stator of the embodiment;

FIG. 7 is a view illustrating a bus bar assembly of the embodiment as viewed from above;

FIG. 8 is a perspective view illustrating a bus bar of the embodiment; and

FIG. 9 is a perspective view illustrating a part of a stator of another example of the embodiment.

### DETAILED DESCRIPTION

A Z-axis direction appropriately illustrated in each drawing is a vertical direction, in which a positive side is an upper side while a negative side is a lower side. A center axis J appropriately illustrated in each drawing is an imaginary line, which is parallel to the Z-axis direction and extends in the vertical direction. In the following description, an axial direction of the center axis J, namely, a direction parallel to the vertical direction is simply referred to as an “axial direction”, a radial direction centered on the center axis J is simply referred to as a “radial direction”, and a circumferential direction centered on the center axis J is simply referred to as a “circumferential direction”. In an embodiment, the upper side corresponds to one side in the axial direction, and the lower side corresponds to the other side in the axial direction. Further, in the embodiment, a radial outside corresponds to one side in the radial direction, and a radial inside corresponds to the other side in the radial direction. The vertical direction, the upper side, and the lower side are merely names for describing a relative positional relationship between the respective units, and an actual layout relationship and the like may be other than the layout relationship indicated by these names.

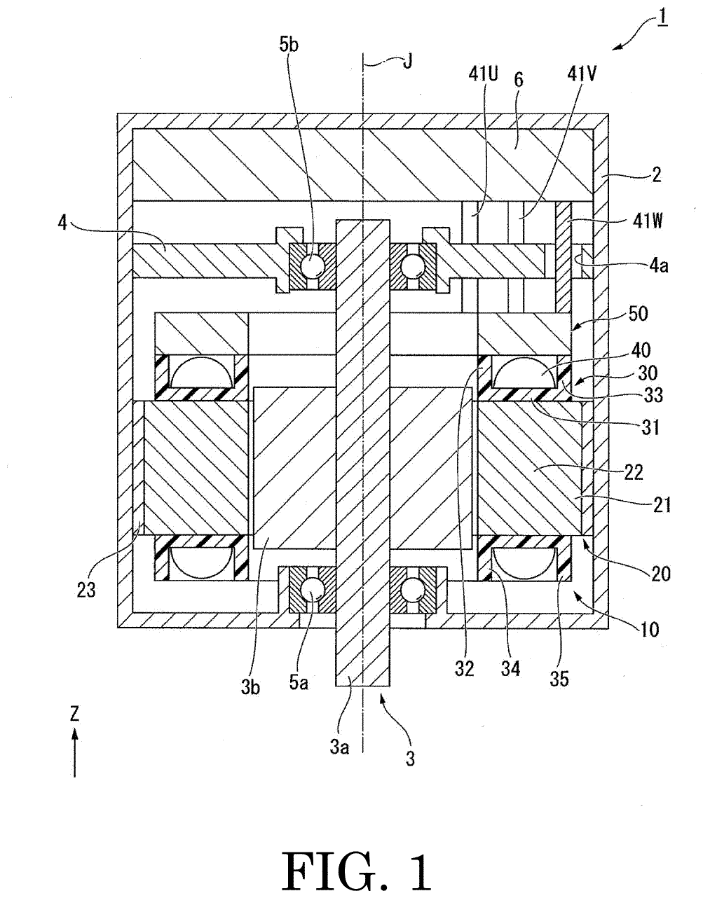

As illustrated in FIG. 1, a motor 1 according to an embodiment includes a housing 2, a rotor 3, a stator 10, a bearing holder 4, bearings 5a, 5b, and a control device 6. The housing 2 accommodates the rotor 3, the stator 10, the bearing holder 4, the bearings 5a, 5b, and the control device 6. The bearing 5a is held at a bottom of the housing 2.

The rotor 3 is radially opposed to the stator 10 with a gap. The rotor 3 includes a shaft 3a and a rotor body 3b. That is, the motor 1 includes the shaft 3a and the rotor body 3b. The shaft 3a rotates about the center axis J. The shaft 3a has a columnar shape that extends in an axial direction while being centered on the center axis J. The shaft 3a is rotatably supported by bearings 5a, 5b. For example, each of the bearings 5a, 5b is a ball bearing. The rotor body 3b is fixed to an outer circumferential surface of the shaft 3a. Although not illustrated, the rotor body 3b includes a rotor core and a rotor magnet fixed to the rotor core.

The bearing holder 4 is located above the stator 10. The bearing holder 4 holds the bearing 5b. The bearing holder 4 includes a holder through-hole 4a axially penetrating the bearing holder 4. Second coil leader wires 41U, 41V, 41W (to be described later) are passed through the holder through-hole 4a. The control device 6 is located above the bearing holder 4. Although not illustrated, the control device 6 includes a power supply that supplies electric power to the stator 10.

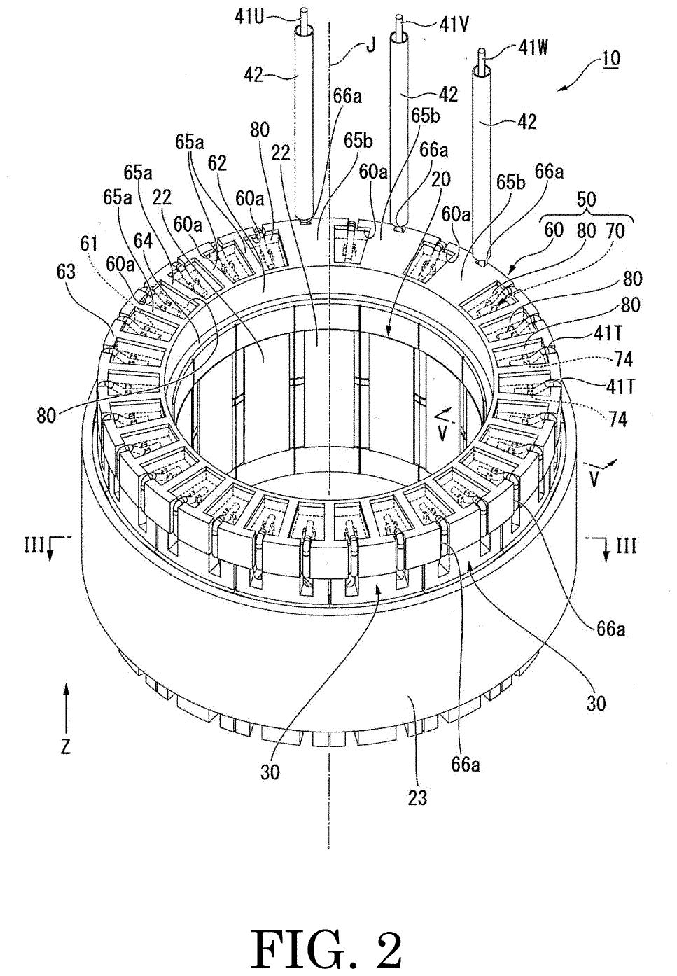

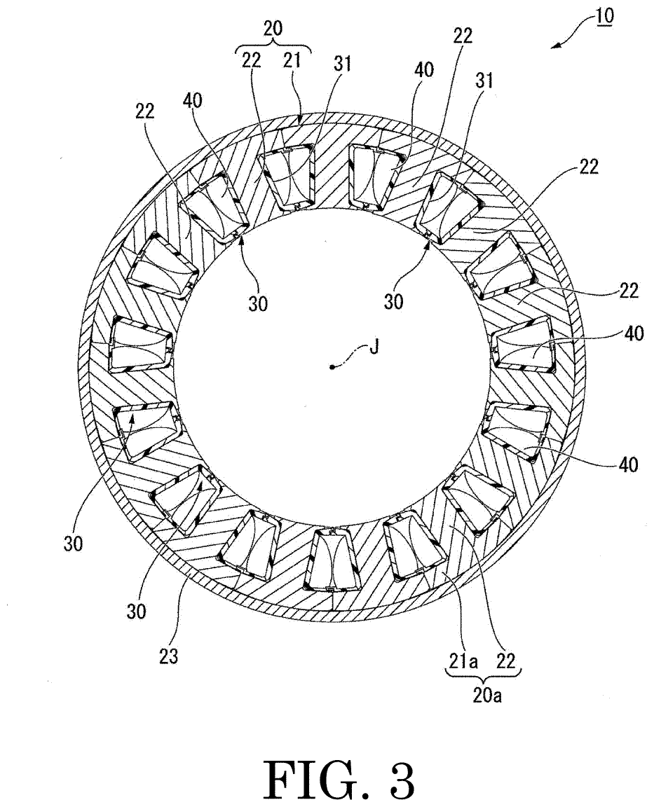

The stator 10 is radially opposed to the rotor 3 with the gap. In the embodiment, the stator 10 is located on the radial outside of the rotor 3. The stator 10 is fixed to an inner circumferential surface of the housing 2. As illustrated in FIGS. 2 and 3, the stator 10 includes a stator core 20, a core cover 23, an insulator 30, a bus bar assembly 50, and a plurality of coils 40.

As illustrated in FIG. 3, the stator core 20 includes a core back 21 extending in the circumferential direction and a plurality of teeth 22 extending in the radial direction from the core back 21. The core back 21 has an annular shape along the circumferential direction. In the embodiment, the core back 21 has an annular shape centered on the center axis J. In the embodiment, the plurality of teeth 22 extend from the core back 21 toward the radial inside. The plurality of teeth 22 are arranged at equal intervals over a whole circumference. For example, 15 teeth 22 are provided.

In the description, the “annular shape along the circumferential direction” may be a shape that is continuously connected over a whole circumference and surrounds the center axis J when viewed along the axial direction. That is, in the description, when “an object is an annular shape along the circumferential direction”, the shape of the object may be a circular shape surrounding the center axis J, an elliptic shape surrounding the center axis J, or a polygonal shape surrounding the center axis J.

In the embodiment, the stator core 20 is configured by circumferentially connecting a plurality of stator core pieces 20a. Each of the plurality of stator core pieces 20a includes one core back piece 21a constituting a circumferential part of the core back 21 and one tooth 22 extending from the core back piece 21a toward the radial inside. Both circumferential ends of the core back piece 21a are in contact with and coupled to a circumferential ends of the core back piece 21a adjacent in the circumferential direction.

The core cover 23 is located on the radial outside of the stator core 20, and has a tubular shape surrounding the stator core 20. In the embodiment, the core cover 23 has a cylindrical shape, which is opened onto both sides in the axial direction while centered on the center axis J. The core cover 23 is fitted in and fixed to the stator core 20. The core cover 23 can prevent separation of the plurality of stator core pieces 20a coupled to each other.

The insulator 30 is mounted on the teeth 22. In the embodiment, the insulator 30 is provided for each tooth 22. As a result, in the embodiment, the plurality of insulators 30 are arranged at equal intervals over a whole circumference. For example, 15 insulators 30 are provided. For example, the insulator 30 is made of resin. As illustrated in FIG. 1, the insulator 30 includes an insulator body 31, a pair of insulator walls 32, 33, and a pair of insulator walls 34, 35. The insulator body 31 has a tubular shape extending in the radial direction. Although not illustrated, the insulator body 31 of the embodiment has a square tubular shape that is opened onto both sides in the radial direction. The tooth 22 is passed through the insulator body 31.

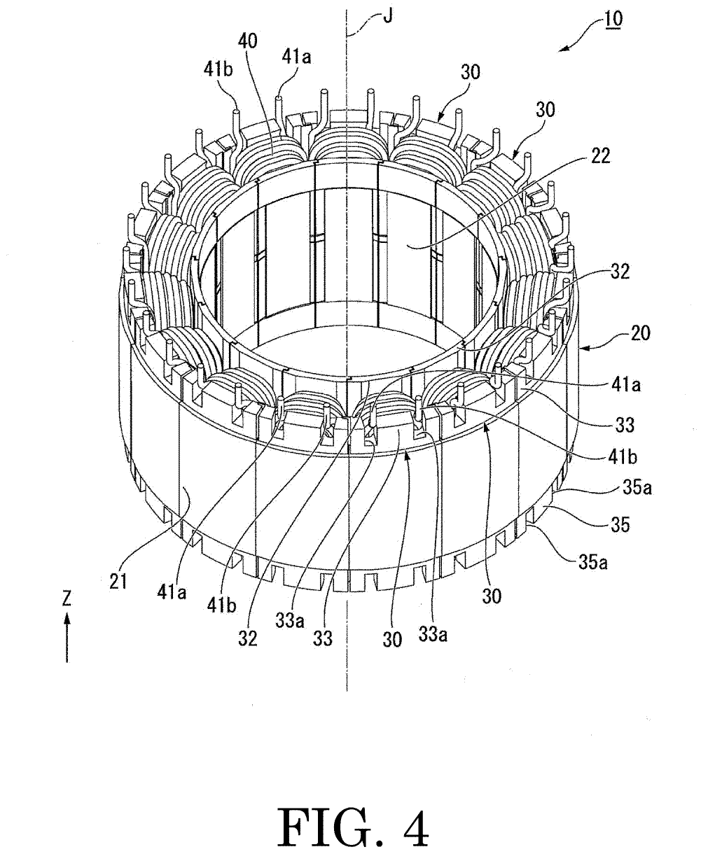

The pair of insulator walls 32, 33 protrude upward from both radial ends of the insulator body 31. The insulator wall 32 protrudes upward from the radially inside end of the insulator body 31. The insulator wall 33 protrudes upward from the radial outside end of the insulator body 31. As illustrated in FIG. 4, the insulator walls 32, 33 have an arc shape that curves along the circumferential direction when viewed along the axial direction. A radial dimension of the insulator wall 33 is larger than a radial dimension of the insulator wall 32. The upper end of the insulator wall 32 and the upper end of the insulator wall 33 are located at the same position in the axial direction. The insulator walls 32 of the insulators 30 adjacent to each other in the circumferential direction are coupled to each other to constitute a cylindrical wall centered on the center axis J.

In the pair of insulator walls 32, 33, the insulator wall 33 located on the radial outside includes a penetration unit 33a radially penetrating the insulator wall 33. The penetration unit 33a is recessed downward from the upper end of the insulator wall 33. The penetration unit 33a is opened upward. In the embodiment, two penetration units 33a are provided for each insulator wall 33. That is, for example, a total of 30 penetration units 33a are provided in the stator 10. In each insulator 30, two penetration units 33a are circumferentially disposed with a gap.

As illustrated in FIG. 1, the pair of insulator walls 34, 35 protrude downward from the radial both ends of the insulator body 31. The insulator wall 34 protrudes downward from the radially inside end of the insulator body 31. The insulator wall 35 protrudes downward from the radially outside end of the insulator body 31. The insulator wall 34 has the same shape as the insulator wall 32 except that the insulator wall 34 is symmetrical in the axial direction. The insulator wall 35 has the same shape as the insulator wall 33 except that the insulator wall 35 is symmetrical in the axial direction. As illustrated in FIG. 4, the insulator wall 35 has a penetration unit 35a radially penetrating the insulator wall 35.

As illustrated in FIG. 2, the bus bar assembly 50 is located above the stator core 20 and the insulator 30. The bus bar assembly 50 includes a bus bar holder 60, a plurality of bus bars 70, and a plurality of resin units 80. That is, the stator 10 includes the bus bar holder 60, the plurality of bus bars 70, and the plurality of resin units 80. The bus bar holder 60 is located above the stator core 20 and the insulator 30. The bus bar holder 60 has an annular shape along the circumferential direction.

In the embodiment, the bus bar holder 60 has an annular shape centered on the center axis J. For example, the bus bar holder 60 is made of resin. For example, the bus bar holder 60 is made by insert molding using a plurality of bus bars 70 as an insert member.

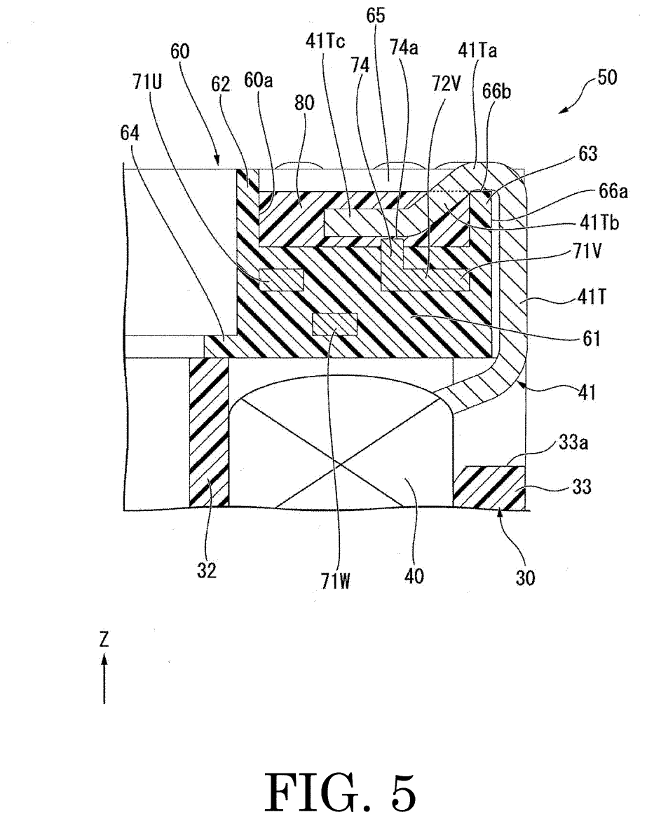

The bus bar holder 60 includes a base 61, an inside wall 62, an outside wall 63, a plurality of sidewalls 65a, 65b, and an annular plate 64. The base 61 has an annular shape along the circumferential direction. In the embodiment, the base 61 has the annular shape centered on the center axis J. As illustrated in FIG. 5, the base 61 is located above the coil 40. A radially inside surface of the base 61 is located on the radial outside of a radially outside surface of the insulator wall 32. The radially outside surface of the base 61 is radially located at the same position as the radially outside surface of the insulator wall 33. A radially outside edge in the lower surface of the base 61 contacts with the upper end of the insulator wall 33. The base 61 is supported from below by the insulator wall 33.

The inside wall 62 protrudes upward from a radially inner edge of the base 61. As illustrated in FIG. 2, the inside wall 62 has an annular shape along the circumferential direction. In the embodiment, the inside wall 62 has the annular shape centered on the center axis J. The radially inside surface of the inside wall 62 is radially located at the same position as the radially inside surface of the base 61. The radially inside surface of the inside wall 62 and the radially inside surface of the base 61 are axially connected to each other.

The outside wall 63 protrudes upward from the radially outside edge of the base 61. The outside wall 63 has an annular shape along the circumferential direction. In the embodiment, the outside wall 63 has the annular shape centered on the center axis J. The radially outside surface of the outside wall 63 is radially located at the same position as the radially outside surface of the base 61. The radially outside surface of the outside wall 63 and the radially outside surface of the base 61 are axially connected to each other. The radial dimension of the outside wall 63 is larger than the radial dimension of the inside wall 62. The upper end of the inside wall 62 and the upper end of the outside wall 63 are axially located at the same position.

The plurality of sidewalls 65a, 65b protrude upward from the base 61. The plurality of sidewalls 65a, 65b extend radially to connect the inside wall 62 and the outside wall 63. The plurality of sidewalls 65a, 65b are disposed apart from each other along the circumferential direction. In the embodiment, a plurality of sidewalls 65a and a plurality of sidewalls 65b are provided. For example, in the embodiment, 24 sidewalls 65a are provided and 3 sidewalls 65b are provided.

The plurality of sidewalls 65a are continuously arranged side by side at equal intervals along the circumferential direction. The plurality of sidewalls 65b are continuously arranged side by side at equal intervals along the circumferential direction while being circumferentially adjacent to the sidewalls 65a continuously arranged side by side. The plurality of sidewalls 65b are located between the sidewalls 65a in the circumferential direction. In the embodiment, a distance between the sidewalls 65a adjacent to each other in the circumferential direction, a distance between the sidewalls 65b adjacent to each other in the circumferential direction, and a distance between the sidewalls 65a and the sidewalls 65b adjacent to each other in the circumferential direction are equal to one another.

A circumferential dimension of the sidewall 65a is uniform over the entire radial direction. A circumferential dimension of the sidewall 65b increases from the radial inside toward the radial outside. The circumferential dimension of the sidewall 65b is larger than the circumferential direction of the sidewall 65a. In the following description, when the sidewalls 65a, 65b are not particularly distinguished from each other, they are simply referred to as a sidewall 65.

The base 61, the inside wall 62, the outside wall 63, and the sidewall 65 constitute a plurality of recesses 60a, which are recessed downward, along the circumferential direction. More particularly, each recess 60a is constructed with the base 61, the inside wall 62, the outside wall 63, and the pair of sidewalls 65 adjacent to each other in the circumferential direction. In the embodiment, for example, 27 recesses 60a are provided. The plurality of recesses 60a are arranged at equal intervals along the circumferential direction except for the two recesses 60a located between the sidewalls 65b in the circumferential direction. The plurality of recesses 60a have the same shape. The recess 60a has a substantially trapezoidal shape when viewed in the axial direction. The circumferential dimension of the recess 60a increases from the radial inside toward the radial outside.

The lower surface in the inside surface of the recess 60a is a surface facing the upper side, and is the upper surface of the base 61. The radially inside surface in the inside surface of the recess 60a is a surface facing the radial outside, and is the radially outside surface of the inside wall 62. The radially outside surface in the inside surface of the recess 60a is a surface facing the radial inside, and is the radially inside surface of the outside wall 63. The surface on one side in the circumferential direction of the inside surface of the recess 60a is the surface on the other side in the circumferential direction of the sidewall 65 located on one side in the circumferential direction of the recess 60a. The surface on the other side in the circumferential direction of the inside surface of the recess 60a is the surface on one side in the circumferential direction of the sidewall 65 located on the other side in the circumferential direction of the recess 60a.

The annular plate 64 protrudes radially inward from the lower end of the base 61. The annular plate 64 has an annular plate shape, which is centered on the center axis J while a plate surface is oriented toward the axial direction. As illustrated in FIG. 5, the annular plate 64 contacts with the upper end of the insulator wall 32. The annular plate 64 is supported from below by the insulator wall 32. In the embodiment, the annular plate 64 is supported by the insulator wall 32, and the base 61 is supported by the insulator wall 33, whereby the bus bar holder 60 is supported from below by the pair of insulator walls 32, 33.

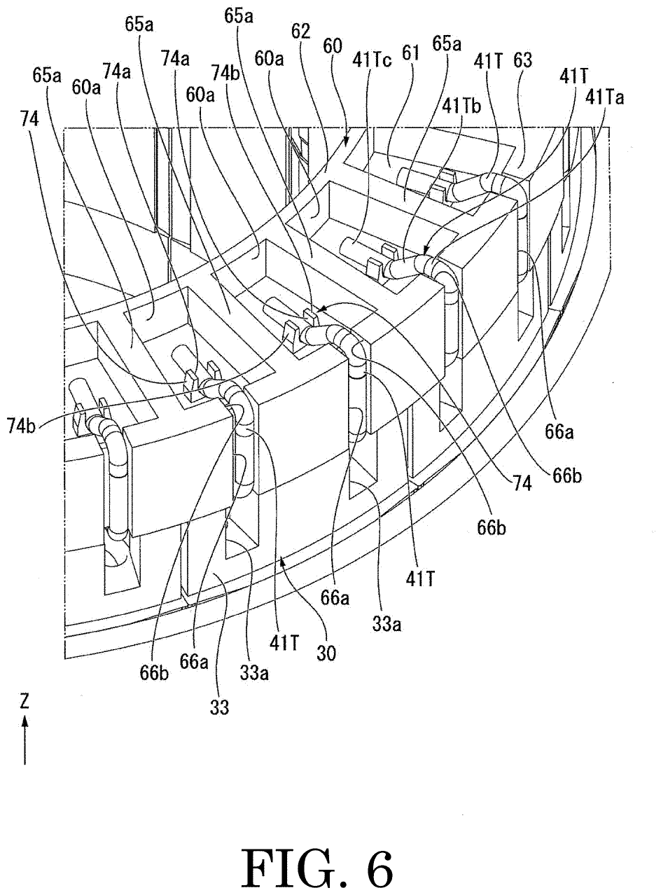

As illustrated in FIG. 6, the bus bar holder 60 has a first groove 66a and a second groove 66b. The first groove 66a is provided on the radially outside surface of the bus bar holder 60. The first groove 66a is recessed radially inward. The first groove 66a extends axially from the lower end of the base 61 to the upper end of the outside wall 63. The first groove 66a is opened onto both sides in the axial direction. In the embodiment, the first groove 66a extends linearly in the axial direction. A plurality of first grooves 66a are provided along the circumferential direction. The plurality of first grooves 66a are arranged at equal intervals over a whole circumference. The number of first grooves 66a is the same as the total number of penetration units 33a, for example, 30 pieces. The plurality of first grooves 66a are located at the same circumferential position as the plurality of penetration units 33a. Each first groove 66a is located above each penetration unit 33a. The lower end of the first groove 66a is connected to the upper end of the penetration unit 33a. Consequently, the inside of the first groove 66a and the inside of the penetration unit 33a are connected to each other.

As illustrated in FIG. 2, in the embodiment, one first groove 66a is located on the radial outside of each recess 60a. One first groove 66a is located on the radial outside of each sidewall 65b. That is, the plurality of first grooves 66a include the plurality of first grooves 66a located on the radial outside of the recess 60a and the plurality of first grooves 66a located on the radial outside of the sidewall 65b. The circumferential center of the first groove 66a located on the radial outside of the recess 60a is circumferentially located at the same position as the center of the recess 60a. The circumferential centers of the plurality of first grooves 66a located on the radial outside of the sidewall 65b are circumferentially located at the same position as the circumferential center of the sidewall 65b.

The second groove 66b is provided at the upper end of the outside wall 63. That is, the second groove 66b is provided at the upper end of the wall located on the radial outside in the inside wall 62 and the outside wall 63. The second groove 66b is recessed downward. The second groove 66b penetrates the outside wall 63 in the radial direction, and is opened onto both sides in the radial direction. The radially outside end of the second groove 66b is connected to the upper end of the first groove 66a. Consequently, the inside of the first groove 66a and the inside of the second groove 66b are connected to each other. A plurality of second grooves 66b are provided along the circumferential direction. Each second groove 66b is provided on the radial outside of each recess 60a. That is, for example, 27 second grooves 66b are provided. The radially inside end of each second groove 66b is connected to each recess 60a. The second groove 66b is provided for each first groove 66a except for the three first grooves 66a through which the second coil leader wires 41U, 41V, 41W (to be described later) are passed.

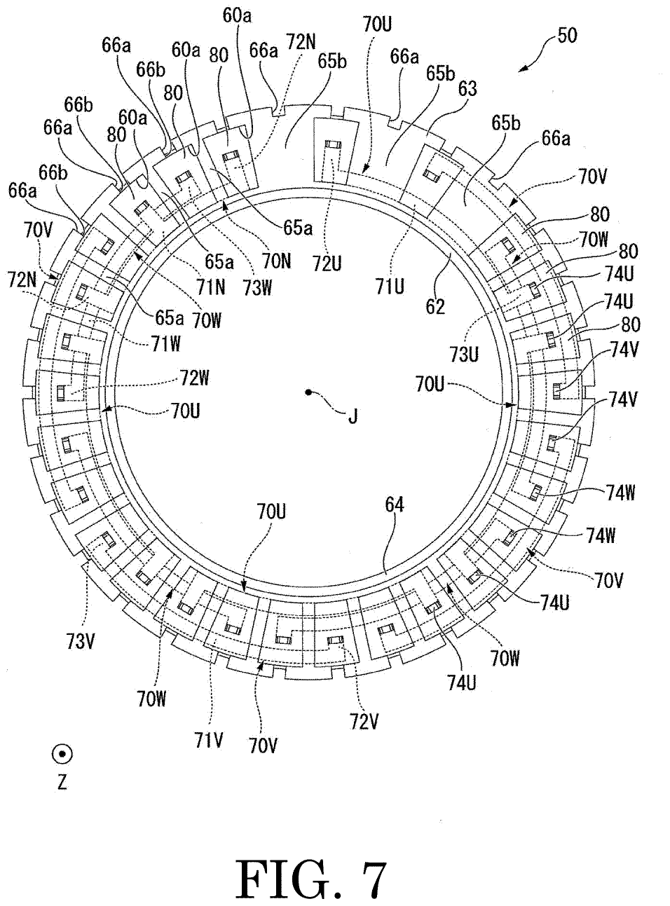

As illustrated in FIG. 7, the plurality of bus bars 70 are held by the bus bar holder 60. In the embodiment, a part of the bus bar 70 is held while embedded in the bus bar holder 60. The plurality of bus bars 70 include compatible bus bars 70U, 70V, 70W and a neutral point bus bar 70N as the bus bar 70. In the embodiment, three phase bus bars 70U, three phase bus bars 70V, and three phase bus bars 70W are provided. One neutral point bus bar 70N is provided.

The three phase bus bars 70U are arranged side by side at intervals along the circumferential direction. The phase bus bar 70U includes a circumferentially extending unit 71U, radially extending units 72U, 73U, and a coil connection unit 74U. The three phase bus bars 70V are arranged side by side at intervals along the circumferential direction. The phase bus bar 70V includes a circumferentially extending unit 71V, radially extending units 72V, 73V, and a coil connection unit 74V. The three phase bus bars 70W are arranged side by side at intervals along the circumferential direction. The phase bus bar 70W includes a circumferentially extending unit 71W, radially extending units 72W, 73W, and a coil connection unit 74W. The neutral point bus bar 70N is located between the phase bus bars 70U adjacent to each other in the circumferential direction. The neutral point bus bar 70N includes a circumferentially extending unit 71N, a radially extending unit 72N, and a coil connection unit 74N. As described above, the plurality of bus bars 70 include the plurality of coil connection units 74U, 74V, 74W, 74N. In the following description, when the coil connection units 74U, 74V, 74W, 74N are not particularly distinguished from one another, they are simply referred to as the coil connection unit 74.

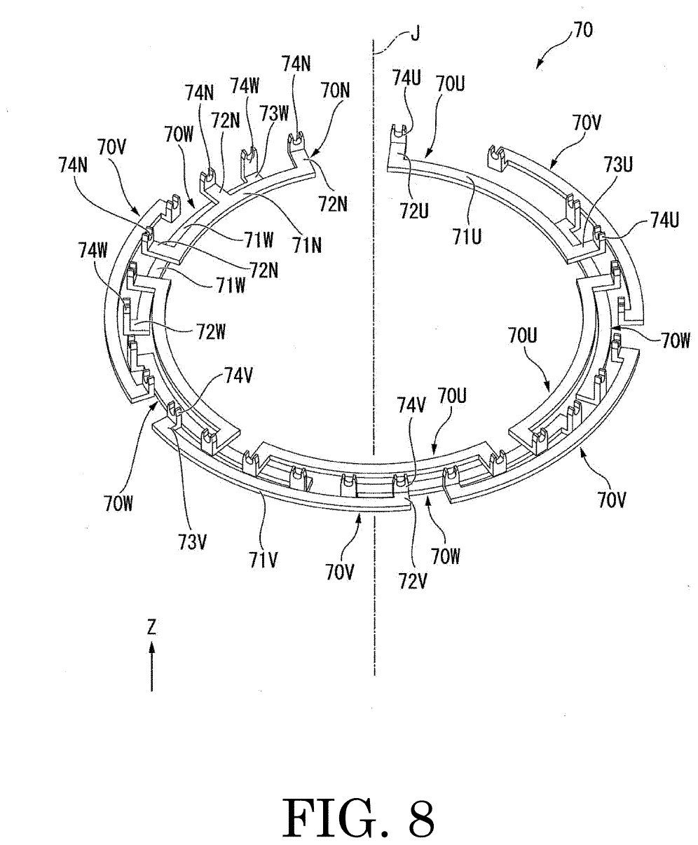

The circumferentially extending units 71U, 71V, 71W, 71N have a plate shape with the plate surface facing the axial direction, and an arc shape extending in the circumferential direction. As illustrated in FIGS. 5 and 7, the circumferentially extending units 71U, 71V, 71W, 71N are embedded in the base 61. As illustrated in FIGS. 7 and 8, the circumferentially extending unit 71V is located on the radial outside of the circumferentially extending unit 71U. The circumferentially extending unit 71W is radially located between the circumferentially extending unit 71U and the circumferentially extending unit 71V. The circumferentially extending unit 71W is radially located closer to the circumferentially extending unit 71U than the circumferentially extending unit 71V. That is, a radial distance between the circumferentially extending unit 71W and the circumferentially extending unit 71U is smaller than a radial distance between the circumferentially extending unit 71W and the circumferentially extending unit 71V. As illustrated in FIG. 5, the circumferentially extending unit 71U and the circumferentially extending unit 71V are located at the same positions in the axial direction. The circumferentially extending unit 71W is located below the circumferentially extending unit 71U and the circumferentially extending unit 71V. As illustrated in FIG. 8, the circumferentially extending unit 71N is located at the same position as the circumferentially extending unit 71U in the radial and axial directions.

As illustrated in FIGS. 7 and 8, the radially extending units 72U, 73U extend radially outward from both ends in the circumferential direction of the circumferentially extending unit 71U. Among the radially extending units 72U, 73U, a part of the radially extending units 72U, 73U radially straddles the upper side of the circumferentially extending unit 71W. The radially extending units 72V, 73V extend radially inward from both ends in the circumferential direction of the circumferentially extending unit 71V. The radially extending units 72W, 73W extend outward from both ends in the circumferential direction of the circumferentially extending unit 71W. The radially extending unit 72N extends radially outward from both ends in the circumferential direction of the circumferentially extending unit 71N and a central portion in the circumferential direction of the circumferentially extending unit 71N. That is, three radially extending units 72N are provided in the neutral point bus bar 70N.

Among the radially extending units 72N, two radially extending units 72N radially straddle the upper side of the circumferentially extending unit 71W. Radial front ends of the radially extending units are located at the same position in the radial direction. Each radially extending unit has a plate shape with the plate surface facing the axial direction.

The coil connection unit 74U protrudes upward from each of the radially outside ends of the radially extending units 72U, 73U. The coil connection unit 74V protrudes upward from each of the radially inside ends of the radially extending units 72V, 73V. The coil connection unit 74W protrudes upward from each of the radially outside ends of the radially extending units 72W, 73W. That is, two coil connection units 74 are provided for each of the phase bus bars 70U, 70V, 70W. The coil connection unit 74N protrudes upward from each of the radially outside ends of the three radially extending units 72N. That is, three coil connection units 74N are provided in the neutral point bus bar 70N.

As illustrated in FIGS. 5 and 6, the plurality of coil connection units 74 protrude upward from the base 61, and are located in the recess 60a. At least one coil connection unit 74 is located in each recess 60a. In the embodiment, one coil connection unit 74 is located in each recess 60a. The coil connection unit 74 protrudes upward from the lower surface in the inside surface of the recess 60a. The lower end of the coil connection unit 74 is embedded in the base 61. The upper end of the coil connection unit 74 is located below the lower surface in the inside surface of the second groove 66b. The lower surface in the inside surface of the second groove 66b is a surface facing the upper side, and is a groove bottom surface of the second groove 66b.

In the embodiment, the coil connection unit 74 has a plate shape with the plate surface facing the radial direction. The coil connection unit 74 includes a gripping recess 74a, which is recessed downward from the upper end of the coil connection unit 74. The gripping recess 74a radially penetrates the coil connection unit 74. The upper end of the coil connection unit 74 is bifurcated by providing the gripping recess 74a. Consequently, the coil connection unit 74 includes a pair of arms 74b circumferentially opposed to each other. The lower surface in the inside surface of the gripping recess 74a is an arc shape that is concave downward when viewed in the radial direction.

As illustrated in FIG. 7, the plurality of coil connection units 74 are circumferentially disposed spaced apart from each other. The plurality of coil connection units 74 are radially located at the same position. In other words, the plurality of coil connection units 74 are disposed on a concentric circle centered on the center axis J when viewed in the axial direction. In the embodiment, the radial positions of the plurality of coil connection units 74 are closer to the outside wall 63 than the inside wall 62. The radial distance between the coil connection unit 74 and the outside wall 63 is smaller than the radial distance between the coil connection unit 74 and the inside wall 62.

The plurality of coil connection units 74 are located at the same circumferential positions as the plurality of second grooves 66b. That is, the coil connection unit 74 is located on the radial inside of the second groove 66b when viewed in the axial direction.

As illustrated in FIG. 1, the plurality of coils 40 are mounted on the plurality of teeth 22 via the insulator 30. More particularly, the coil 40 is mounted on each of the plurality of teeth 22 via the insulator body 31. As illustrated in FIG. 4, for example, 15 coils 40 are provided. Each of the plurality of coils 40 is constructed with a conducting wire as a conductive member. More particularly, each of the plurality of coils 40 is configured such that the conductive wire is wound around each insulator body 31. In the embodiment, each coil 40 is constructed with one conductive wire. The conductive member constituting the coil 40 may be a plate-shaped member (for example, a metal plate) instead of a linear conducting wire. The coil 40 may be configured by combining a plurality of plate-shaped members (for example, metal plates) or the like. The coil 40 may be configured such that the conductive wire is wound after the insulator 30 is attached to the tooth 22. The coil 40 may previously be configured by the conductive member such as the conductive wire, and the coil 40 may be mounted on the tooth 22.

A pair of coil leader wires 41a, 41b are led upward from each of the plurality of coils 40. The pair of coil leader wires 41a, 41b are both ends of the conductive wire constituting the coil 40. The coil leader wire 41a is an end on a winding start side of the conductive wire constituting the coil 40. The coil leader wire 41b is an end on a winding end side of the conductive wire constituting the coil 40. In the embodiment, both the coil leader wires 41a, 41b are led upward from the radially outside end of the coil 40. In the following description, when the coil leader wire 41a and the coil leader wire 41b are not particularly distinguished from each other, they are simply referred to as a coil leader wire 41. In the embodiment, the coil leader wire 41 corresponds to the coil leader.

The coil leader wire 41 lead upward from the coil 40 is bent onto the radial outside, and a part of the coil leader wire 41 is located in the penetration unit 33a. As illustrated in FIG. 5, the coil leader wire 41 is bent upward in the penetration unit 33a, and passed through the first groove 66a. Consequently, in the embodiment, each of the coil leader wires 41 is led upward through the radial outside of the bus bar holder 60.

As illustrated in FIG. 2, among the coil leader wires 41 in the plurality of coils 40, a part of the coil leader wires 41 is the second coil leader wires 41U, 41V, 41W, and other coil leader wires 41 are a first coil leader wire 41T. In the embodiment, the first coil leader wire 41T corresponds to the first coil leader, and the second coil leader wires 41U, 41V, 41W correspond to the second coil leader.

In the embodiment, the second coil leader wires 41U, 41V, 41W are a coil leader wire 41b, which is an end on the winding end side of the conductive wires constituting the coil 40. The second coil leader wires 41U, 41V, 41W are passed through the first groove 66a, and linearly lead upward. An insulating tube 42 is mounted on the second coil leader wires 41U, 41V, 41W. The insulating tube 42 is a member, such as resin and insulating paper, which has an insulating property. As illustrated in FIG. 1, the second coil leader wires 41U, 41V, 41W extend to the upper side of the bearing holder 4 through the holder through-hole 4a, and are connected to the control device 6. That is, the second coil leader wires 41U, 41V, 41W are the coil leader wire 41, which is led upward and directly connected to the control device 6. Consequently, the stator 10 is electrically connected to the control device 6. As described above, in the embodiment, the second coil leader wires 41U, 41V, 41W lead upward from the coil 40 can be directly connected to the control device 6, so that the stator 10 and the control device 6 are easily connected to each other. The second coil leader wires 41U, 41V, 41W are connected to a power supply (not illustrated) of the control device 6. Consequently, power is supplied from the power supply to the coil 40 via the second coil leader wires 41U, 41V, 41W. Phases of currents passed from the power supply to the second coil leader wires 41U, 41V, 41W are different from each other.

As illustrated in FIGS. 5 and 6, the front end of the first coil leader wire 411 is bent onto the radial inside and accommodated in the recess 60a. The front end of at least one first coil leader wire 411 is accommodated in each recess 60a. In the embodiment, the front end of each first coil leader wire 411 is accommodated in each recess 60a. The front end of the first coil leader wire 411 is connected to the coil connection unit 74 in the recess 60a. Consequently, the coil connection unit 74 is connected to the coil 40, and the bus bar 70 is electrically connected to the coil 40. In the embodiment, the front end of the first coil leader wire 411 passes through the inside of the second groove 66b, is bent onto the radial inside, and is accommodated in the recess 60a. The front end of the first coil leader wire 411 is gripped between the pair of arms 74b in the circumferential direction. For this reason, the first coil leader wire 411 can be prevented from moving in the circumferential direction, and the first coil leader wire 411 can be stably connected to the coil connection unit 74.

The front end of the first coil leader wire 41T includes a first portion 41Ta, a second portion 41Tb, and a third portion 41Tc. The first portion 41Ta is a portion located in the second groove 66b. The second portion 41Tb is a portion extending diagonally downward on the radial inside from the radially inside end of the first portion 41Ta. The third portion 41Tc is a portion extending linearly radially outward from the radially inside end of the second portion 41Tb. In the embodiment, the radially outside end of the third portion 41Tc is gripped by the pair of arms 74b, and connected to the coil connection unit 74. The third portion 41Tc is located below the first portion 41Ta.

Although not illustrated, the front end of the first coil leader wire 41T of the embodiment is fixed to the coil connection unit 74 by welding. For this reason, the first coil leader wire 41T and the coil connection unit 74 can be more firmly connected to each other, and the coil 40 and the bus bar 70 can be certainly and electrically connected to each other. In the embodiment, the third portion 41Tc is fixed to the coil connection unit 74 by welding. A method for welding the front end of the first coil leader wire 41T and the coil connection unit 74 is not particularly limited. For example, the front end of the first coil leader wire 411 and the coil connection unit 74 are welded by resistance welding using an electrode in which the pair of arms 74b are sandwiched from both sides in the circumferential direction.

In the embodiment, the coil leader wire 41a, which is the end on the winding start side of the conductive wire in the first coil leader wire 411, is connected to the coil connection unit 74 connected to the radially extending units 72U, 72V, 72W, 72N. The coil leader wire 41b, which is the end on the winding end side of the conductive wire in the first coil leader wire 411, is connected to the coil connection unit 74 connected to the radially extending units 73U, 73V, 73W. The plurality of coils 40 are electrically connected to each other by connecting the first coil leader wire 411 to each coil connection unit 74. Specifically, five coils 40 are connected in series by three phase bus bars 70U. Five coils 40, which are different from the coils 40 connected to the phase bus bar 70U, are connected in series by three phase bus bars 70V. The remaining five coils 40 are connected in series by three phase bus bars 70W. A group of the coils 40 connected in series by each of the phase bus bars 70U, 70V, 70W is connected via the neutral point bus bar 70N. In this way, the plurality of coils 40 of the embodiment are connected by star connection.

In the embodiment, the pair of coil leader wires 41a, 41b, which are both ends of the conductive wire constituting the coil 40, are led from each of the coils 40. Each of the coil leader wires 41a, 41b is either the second coil leader wires 41U, 41V, 41W connected to the power source or the first coil leader wire 411 connected to the coil connection unit 74. For this reason, the coils 40 are connected to each other only via the bus bar 70, and the crossover wire connecting the coils 40 is not provided. Consequently, a process of mounting the insulating tube to the crossover wire and a process of arranging the crossover wire in the circumferential direction can be eliminated.

The front end of the lead first coil leader wire 411 is bent onto the radial inside, accommodated in the recess 60a, and connected to the coil connection unit 74. For this reason, it is not necessary to arrange the first coil leader wire 411 in the circumferential direction, and the first coil leader wire 411 can be easily connected to the coil connection unit 74. Consequently, the first coil leader wires 411 can be insulated from each other without providing an insulating tube in the first coil leader wire 411, and a short circuit between the first coil leader wires 411 can be prevented. Since the front end of the first coil leader wire 411 is accommodated in the recess 60a of the bus bar holder 60, the first coil leader wire 411 and the coil 40 can also be insulated from each other, and a short circuit between the first coil leader wire 411 and the coil 40 can also be prevented. It is not necessary to arrange the coil leader wire 41 in the circumferential direction, so that work of accommodating the coil leader wire 41 in the recess 60a is easy to automate. As described above, in the embodiment, the man-hours and time required for assembling the stator 10 can be reduced, and the productivity of the stator 10 can be improved.

In the embodiment, a plurality of recesses 60a are provided along the circumferential direction. For this reason, the first coil leader wires 411 accommodated in different recesses 60a are blocked by the sidewall 65, and prevented from contacting with each other. A creeping distance between the first coil leader wires 411 is increased by providing the sidewall 65, and the first coil leader wires 411 accommodated in different recesses 60a can be suitably insulated from each other.

In the embodiment, one coil connection unit 74 is located in each recess 60a, and the front end of one first coil leader wire 411 is accommodated in each recess 60a. For this reason, all the first coil leader wires 411 can be suitably insulated from each other.

In the embodiment, radial positions of the plurality of coil connection units 74 are identical to each other. For this reason, the work of connecting each coil connection unit 74 and each first coil leader wire 411 can be performed at the same radial position. Consequently, the coil connection unit 74 and the first coil leader wire 411 can be more easily connected to each other.

In the embodiment, the coil leader wire 41 is passed through the first groove 66a. For this reason, the coil leader wire 41 lead upward through the radial outside of the bus bar holder 60 can be held in the first groove 66a. Consequently, the coil leader wire 41 can be positioned in the circumferential direction, and the coil leader wire 41 can be prevented from moving in the circumferential direction. Thus, the work of connecting the coil leader wire 41 can be easily performed.

In the embodiment, the plurality of first grooves 66a include the first groove 66a located on the radial outside of the recess 60a. For this reason, the circumferential position of the first coil leader wire 411 can be aligned with the circumferential position of the recess 60a by passing the first coil leader wire 411 through the first groove 66a. Consequently, the front end of the first coil leader wire 411 can be easily guided to the recess 60a.

In the embodiment, the coil connection unit 74 is located on the radial inside of the second groove 66b when viewed in the axial direction. The front end of the first coil leader wire 411 is bent through the inside of the second groove 66b, and accommodated in the recess 60a. For this reason, the front end of the first coil leader wire 411 can be guided to the coil connection unit 74 via the inside of the second groove 66b. Consequently, the front end of the first coil leader wire 411 can be easily guided to the coil connection unit 74, and the work of connecting the first coil leader wire 411 and the coil connection unit 74 can be more easily performed.

As illustrated in FIG. 2, the plurality of resin units 80 are a resin portion located in the plurality of recesses 60a. In the embodiment, the resin unit 80 is formed by curing an adhesive poured into the recess 60a. As illustrated in FIG. 5, in the embodiment, a portion of the recess 60a up to the same height as the groove bottom surface of the second groove 66b is filled with the resin unit 80.

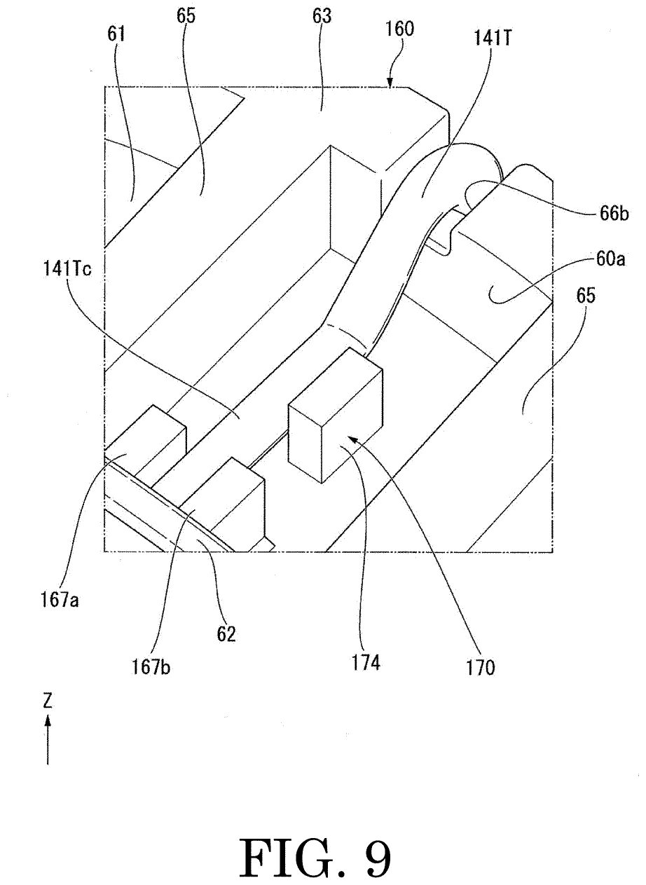

The coil connection unit 74, a part of the second portion 41Tb, and the third portion 41Tc are embedded in the resin unit 80. That is, the resin unit 80 covers the coil connection unit 74 and a part of the front end of the first coil leader wire 41T. For this reason, the resin unit 80 prevents a liquid or the like from coming into contact with the coil connection unit 74 from the outside. Thus, for example, even if the liquid invades into the motor 1, the coil connection unit 74 can be insulated by the resin unit 80. The case where the motor 1 is mounted on a compressor can be cited as an example of the case where the liquid invades into the motor 1. In this case, the liquid such as a refrigerant and a refrigerating machine oil occasionally invades into the motor 1. As described above, the effect that the coil connection unit 74 can be insulated by the resin unit 80 is particularly useful when the motor 1 is mounted on the compressor, for example. The resin unit 80 is not illustrated in FIGS. 6 and 9. In the recess 60a, the portion up to a height of the groove bottom surface of the second groove 66b may be filled with the resin unit 80. Even in this case, desirably the coil connection unit 74 is covered with the resin unit 80. The entire inside of the recess 60a may not be filled with the resin unit 80, but only the coil connection unit 74 and its surroundings may be covered with the resin unit 80.

An operator or the like who assembles the stator 10 of the embodiment assembles the stator core 20 by circumferentially connecting a plurality of assemblies in each of which the insulator 30 and the coil 40 are mounted on the stator core piece 20a. At this point, the coil leader wire 41 is linearly lead upward from the coil 40. The operator or the like fits the core cover 23 in the assembled stator core 20. Subsequently, the operator or the like bends all the coil leader wires 41 onto the radial outside. In this state, the operator or the like disposes the bus bar holder 60 holding the bus bar 70 on the upper side of the insulator 30.

At this point, in the embodiment, the penetration unit 33a is provided in the insulator wall 33 of the insulator 30. For this reason, the first coil leader wire 41T is bent onto the radial outside via the penetration unit 33a, whereby the bus bar holder 60 can be brought into contact with the upper ends of the insulator walls 32, 33 while the first coil leader wire 411 is released radially outward from the insulator wall 33. Consequently, the bus bar holder 60 can be stably supported by the insulator 30, and the work of bending the first coil leader wire 411 can be easily performed.

Subsequently, the operator or the like upwardly bends all the coil leader wires 41, and inserts them into the first grooves 66a from the radial outside. Then, the operator or the like mounts the insulating tube 42 on the second coil leader wires 41U, 41V, 41W of the coil leader wire 41. The operator or the like bends the first coil leader wire 411 of the coil leader wire 41 onto the radial inside via the inside of the second groove 66b and inserts the first coil leader wire 41 into the recess 60a. The operator or the like fits the front end of the first coil leader wire 411 inserted into the recess 60a in a gap between the pair of arms 74b. The operator or the like fixes the front end of the first coil leader wire 411 and the coil connection unit 74 by welding.

In the embodiment, each of the coil leader wires 41 is led upward through the radial outside of the bus bar holder 60, so that the method for upwardly leading the coil leader wire 41 after bending the coil leader wire 41 onto the radial outside can be adopted as described above. Consequently, the work of bending the coil leader wire 41 can be performed on the radial outside of the bus bar holder 60, and a work space is easy to ensure. Thus, the work of pleading the coil leader wire 41 can be easily performed as compared with the case where the coil leader wire 41 is led upward through the radial inside of the bus bar holder 60.

Subsequently, the operator or the like pours an uncured adhesive into the plurality of recesses 60a using a dispenser or the like to form the resin unit 80. At this point, for example, when the plurality of recesses 60a are one recess connected in the circumferential direction, a volume of the recess becomes relatively large, and an amount of adhesive poured into the recess tends to become relatively large. For this reason, there is a risk that material cost of the resin unit 80 is increased to increase manufacturing cost of the stator 10.

On the other hand, in the embodiment, a radial gap between the inside wall 62 and the outside wall 63 is circumferentially partitioned by the sidewall 65, and the plurality of recesses 60a are provided along the circumferential direction. For this reason, the total volume in the recess 60a can be reduced by the amount of the sidewall 65 as compared with the case where the plurality of recesses 60a are circumferentially coupled to each other to form one recess without providing the sidewall 65. Consequently, the amount of adhesive poured into the recess 60a can be reduced, and the material cost of the resin unit 80 can be reduced. Thus, the manufacturing cost of the stator 10 can be reduced. The amount of adhesive poured per one recess 60a is reduced, so that the time necessary for curing the poured adhesive can be shortened. Consequently, the time required for manufacturing the stator 10 can be shortened, and the productivity of the stator 10 can be further improved.

In the embodiment, for example, a plurality of discharge ports through which the adhesive is poured into the recesses 60a are provided along the circumferential direction, and the adhesive can be poured into the plurality of recesses 60a at one time. The operator or the like rotates the dispenser or the bus bar holder 60 about the center axis J, and sequentially pours the adhesive into the plurality of recesses 60a.

In the embodiment, the upper end of the coil connection unit 74 is located below the groove bottom surface of the second groove 66b. For this reason, the entire coil connection unit 74 can be covered with the adhesive without putting the adhesive in the upper side of the groove bottom surface of the second groove 66b. Consequently, the coil connection unit 74 can be covered with the resin unit 80 while the adhesive is prevented from leaking out of the second groove 66b. As described above, the stator 10 is assembled.

In the description, the “worker or the like” includes a worker who assembles the stator 10 and an assembly apparatus that assembles the stator 10. The stator 10 may be assembled by the operator alone, the assembling device alone, or the operator and the assembling device.

The present invention is not limited to the above embodiment, and another configuration may be adopted. The number of recesses is not particularly limited as long as at least two recesses are provided. At least two coil connection units may be located in the recess, and the front ends of at least two first coil leaders (first coil leader wires) may be accommodated in the recess. The number of coil connection units located in one recess and the number of front ends of the first coil leader accommodated in one recess may vary for each recess. The shape of the recess is not particularly limited. The recess may have an arc shape extending in the circumferential direction. The first groove need not be provided. The second groove need not be provided. The resin unit may be made of a material other than the adhesive as long as the resin unit is made of resin. The resin unit may be provided only in a part of the recesses. The pump need not be provided. The number of coil connection units included in the bus bar is not particularly limited, and may be one or four or more. That is, in the description, “the plurality of bus bars include the plurality of coil connection units” means that the total number of coil connection units included in the plurality of bus bars may be two or more.

In the above-described embodiment, all the coil leader wires 41 are drawn upward through the radial outer side of the bus bar holder 60, but the present invention is not limited to this. All the coil leaders (coil leader wires) may be led upward through the radial inside of the busbar holder, or a part of the coil leaders may be led upward through the radial outside of the bus bar holder while other coil leaders may be led upward through the radial inside of the bus bar holder. One of the pair of coil leaders extending from one coil may be led upward through the radial inside of the bus bar holder, and the other may be led upward through the radial outside of the bus bar holder. When the coil leader is led upward through the radial inside of the bus bar holder, the first groove may be provided in the radially inside surface of the bus bar holder, and the second groove may be provided at the upper end of the inside wall.

In the above embodiment, the pair of coil leader wires 41a, 41b extending from the coil 40 are configured to extend upward from the radial outside of the coil 40. However, the present invention is not limited to this configuration. Both the pair of coil leaders (coil leader wires) extending from the coil may extend upward from the radially inside portion of the coil, or one of the pair of coil leaders may extend upward from the radially outside portion of the coil while the other may extend upward from the radially inside portion of the coil. The coil leader need not have the linear shape. For example, when the coil is constructed with a plate-shaped member, the coil leader may have the plate shape.

The first coil leader and the coil connection unit may be connected to each other in any way as long as they are connected to each other. The first coil leader and the coil connection unit need not be welded. The first coil leader and the coil connection unit may be fixed to each other by a conductive adhesive, connected to each other via another conductive member, or connected to each other by soldering. When the first coil leader and the coil connection unit are connected to each other via another conductive member, for example, a metal plate is used as the conductive member, and the first coil leader and the coil connection unit may be connected to each other by caulking the metal plate. The radial positions of the plurality of coil connection units may be different from each other. The shape of the coil connection unit is not particularly limited.

The second coil leader (second coil leader wire) need not be provided. In this case, all the coil leaders are the first coil leader (first coil leader wires) accommodated in the recess. In this case, for example, a part of the first coil leaders is connected to the control device via the control device connecting bus bar held by the bus bar holder. In this case, the control device connecting bus bar includes a terminal extending to the control device via the holder through-hole.

The coil connection unit may have a shape of a coil connection unit 174 in FIG. 9. As illustrated in FIG. 9, the coil connection unit 174 of a bus bar 170 has a plate shape with the plate surface facing the circumferential direction. The coil connection unit 174 does not include the pair of arms 74b unlike the coil connection unit 74 of the above embodiment. The coil connection unit 174 is located on one side in the circumferential direction of a third portion 141Tc in a first coil leader wire 141T. The coil connection unit 174 is connected to the radially outside end of the third portion 141Tc. In this configuration, it is not necessary to provide the pair of arms 74b in the coil connection unit 174, so that the bus bar 170 can be easily manufactured. In the configuration of FIG. 9, the first coil leader wire 141T corresponds to the first coil leader.

In the configuration of FIG. 9, a bus bar holder 160 includes a pair of protrusions 167a, 167b protruding upward from the base 61. The pair of protrusions 167a, 167b are disposed apart from each other in the circumferential direction. The radially inside ends of the pair of protrusions 167a, 167b are connected to the radially inside surface of the inside wall 62. The circumferential center between the pair of protrusions 167a, 167b is located at the same position as the circumferential center of the second groove 66b in the circumferential direction. The protrusion 167b is located on the radial inside of the coil connection unit 174. Although not illustrated, the pair of protrusions 167a, 167b are provided for each coil connection unit 174 located in the recess 60a. When one coil connection unit 174 is located in the recess 60a similarly to the above embodiment, the pair of protrusions 167a, 167b are provided for each recess 60a.

The radially inside end of the third portion 141Tc is gripped between the pair of protrusions 167a, 167b in the circumferential direction. Consequently, the front end of the first coil leader wire 141T is gripped between the pair of protrusions 167a, 167b in the circumferential direction. Thus, even if the pair of arms 74b are not provided in the coil connection unit 174, the first coil leader wire 141T can be prevented from moving in the circumferential direction, and the first coil leader wire 141T and the coil connection unit 174 can be easily performed.

For example, each coil may be configured by winding a plurality of bundled conductive wires. In this case, each coil leader wire is both ends of the plurality of bundled conductive wires. The insulator need not be provided. The plurality of coils may form a plurality of coil groups having different power systems. In this case, the power is independently supplied to each coil group. In this case, the recess in which the front end of the first coil leader is accommodated may be separated for each different power system.

The motor of the above embodiment is a three-phase motor. The number of phases of the motor is not limited to the three phases, but the motor of the embodiment may be a single-phase motor, a two-phase motor, or a multi-phase motor of four phases or more. Depending on the number of phases, the number and shape of the phase bus bars and the like are also changed as appropriate.

The application of the motor of the above embodiment is not particularly limited, but the motor may be mounted on a device other than the compressor. The configurations described in the description can be combined as appropriate within a scope that does not give rise to mutual contraction.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A stator of a motor including a shaft that rotates about a center axis, the stator comprising:
a stator core including a core back extending in a circumferential direction and a plurality of teeth extending in a radial direction from the core back;
a plurality of coils that are constructed with a conductive member and mounted on the plurality of teeth;
a bus bar holder that has an annular shape along the circumferential direction and is located on one side in an axial direction of the stator core; and
a plurality of bus bars that are held by the bus bar holder and electrically connected to the coil,
wherein the bus bar holder includes:
an annular base along the circumferential direction;
an annular inside wall protruding from a radially inner edge of the base toward one side in the axial direction;
an annular outside wall protruding from a radially outer edge portion of the base toward one side in the axial direction; and
a plurality of sidewalls that protrude from the base toward one side in the axial direction and extend in the radial direction to connect the inside wall and the outside wall,
the plurality of sidewalls are disposed apart from each other along the circumferential direction,
the base, the inside wall, the outside wall, and the sidewall constitute a plurality of recesses, which are recessed on the other side in the axial direction, along the circumferential direction,
the plurality of bus bars include a plurality of coil connection units connected to the coil,
the plurality of coil connection units are disposed apart from each other along the circumferential direction, and located in each recess while protruding from the base toward one side in the axial direction,
a pair of coil leaders, which are both ends of the conductive member, are led from each of the plurality of coils toward one side in the axial direction through one side in the radial direction of the bus bar holder,
among the coil leaders in the plurality of coils, at least a part of the coil leaders is a first coil leader that is accommodated in the recess while a front end is bent onto the other side in the radial direction,
at least one of the coil connection units is located in each recess, and the front end of at least one of the coil leader is accommodated in each recess, and
the front end of the first coil leader is connected to the coil connection unit in the recess.

2. The stator according to claim 1, wherein one coil connection unit is located in each recess, and the front end of each first coil leader is accommodated in each recess.

3. The stator according to claim 1, wherein the plurality of coil connection units are radially located at an identical position.

4. The stator according to claim 1, wherein a first groove extending in the axial direction is provided on a surface on one side in the radial direction of the bus bar holder,
the first groove is opened onto both sides in the axial direction, and
the coil leader is passed through the first groove.

5. The stator according to claim 4, wherein a plurality of the first grooves are provided along the circumferential direction, and
the plurality of first groove include a first groove located on one side in the radial direction of the recess.

6. The stator according to claim 4, wherein a second groove recessed on the other side in the axial direction is provided at an end on one side in the axial direction of the wall located on one side in the radial direction in the inside wall and the outside wall,
the second groove is opened onto both sides in the radial direction,
an end on one side in the radial direction of the second groove is connected to an end on one side in the axial direction of the first groove,
an end on the other side in the radial direction of the second groove is connected to the recess,
the coil connection unit is located on the other side in the radial direction of the second groove portion when viewed in the axial direction, and
the front end of the first coil leader is bent through an inside of the second groove and accommodated in the recess.

7. The stator according to claim 6, wherein the end on one side in the axial direction of the coil connection unit is located closer to the other side in the axial direction than a surface on the other side in the axial direction among inside surfaces of the second groove.

8. The stator according to claim 1, further comprising a plurality of resin units located in the plurality of recesses,
wherein the resin unit covers the coil connection unit.

9. The stator according to claim 1, wherein each of the coil leaders is led to one side in the axial direction through a radial outside of the bus bar holder.

10. The stator according to claim 1, further comprising an insulator mounted on the teeth,
wherein the coil is mounted on the tooth via the insulator,
the bus bar holder is located on one side in the axial direction of the insulator,
the insulator includes:
a tubular insulator body through which the tooth is passed; and
a pair of insulator walls protruding from both ends in the radial direction of the insulator body toward one side in the axial direction,
the pair of insulator walls support the bus bar holder from the other side in the axial direction,
the insulator wall located on one side in the radial direction in the pair of insulator walls includes a penetration unit radially penetrating the insulator wall,
the penetration unit is opened onto one side in the axial direction, and
a part of the coil leader is located in the penetration unit.

11. The stator according to claim 1, wherein the coil connection unit includes a pair of arms opposed to each other in the circumferential direction, and
the front end of the first coil leader is circumferentially gripped between the pair of arms.

12. The stator according to claim 1, wherein the coil connection unit has a plate shape with a plate surface facing the circumferential direction,
the bus bar holder includes a pair of protrusions protruding from the base toward one side in the axial direction,
the pair of protrusions is disposed apart from each other in the circumferential direction, and
the front end of the first coil leader is circumferentially gripped between the pair of protrusions.

13. The stator according to claim 1, wherein the front end of the first coil leader is fixed to the coil connection unit by welding.

14. A motor comprising:
the stator according to claim 1; and
a rotor radially opposed to the stator with a gap.

15. The motor according to claim 14, further comprising a control device electrically connected to the stator,
wherein among the coil leaders in the plurality of coils, a part of the coil leaders is a second coil leader that is led to one side in the axial direction and directly connected to the control device.
